(19) United States
(12) Patent Application Publication
(10) Pub. No.: US 2003/0215694 A1
(43) Pub. Date: Nov. 20, 2003

(54) Fuel-cell and separator thereof

(76) Inventors: Ken Nomura, Okazaki-shi (JP); Mikio Wada, Nishikamo-gun (JP); Yuichi Yagami, Susono-shi (JP); Tsuyoshi Takahashi, Nishikamo-gun (JP)

Correspondence Address: KENYON & KENYON, 1500 K STREET, N.W., SUITE 700, WASHINGTON, DC, 20005, US

(21) Appl. No.: 10/438,884

(22) Filed: May 16, 2003

(30) Foreign Application Priority Data
May 16, 2002 (JP) 2002-141046

(51) Int. Cl. H01M 8/02

(52) U.S. Cl. 429/38; 429/39

(57) ABSTRACT

In a fuel-cell separator, a gas flow channel, in which an “inverse S”-shaped gas flow channel and an S-shaped gas flow channel are formed symmetrical to each other and converge at their downstream portions in such a manner as to have gas flow channel portions in common, is disposed in a separator face. The cross-sectional area of the common gas flow channel portions is smaller than the sum of the cross-sectional areas of non-common gas flow channel portions that are located upstream of a confluent portion.

### INCORPORATION BY REFERENCE

The disclosure of Japanese Patent Application No. 2002-141046 filed on May 16, 2002, including the specification, drawings, and abstract is incorporated herein by reference in its entirety.

### BACKGROUND OF THE INVENTION

1. Field of the Invention

The invention relates to a fuel cell and a separator thereof. More particularly, the invention relates to a polymer electrolyte fuel cell and a separator thereof.

2. Description of the Related Art

A polymer electrolyte fuel cell is constructed by laminating modules. Each of the modules is obtained by superimposing one or more cells, each of which is composed of a membrane-electrode assembly (MEA) and a separator.

The MEA is composed of an electrolytic membrane made of an ion exchange membrane, an electrode (anode) made of a catalytic layer disposed on one face of the electrolytic membrane, and an electrode (cathode) made of a catalytic layer disposed on the other face of the electrolytic membrane. In general, a diffusion layer is provided between the MEA and the separator. This diffusion layer is adapted to promote diffusion of reactive gases into the catalytic layers. A fuel gas flow channel for supplying the anode with fuel gas (hydrogen) and an oxidative gas flow channel for supplying the cathode with oxidative gas (oxygen, usually air) are formed in the separator. The separator constitutes a passage of electrons moving between adjacent ones of the cells.

At either end of a laminated-cell body in the direction in which the cells are laminated, a terminal (electrode plate), an insulator, and an end plate are disposed. The laminated-cell body is clamped in the direction in which the cells are laminated. The laminated-cell body is fixed on the outside thereof by means of bolts and a fastening member (e.g., a tension plate) extending in the direction in which the cells are laminated, whereby a stack is formed.

On the anode side of the polymer electrolyte fuel cell, a reaction of turning one hydrogen molecule into two hydrogen ions (protons) and two electrons occurs. The hydrogen ions move toward the cathode side in the electrolyte membrane. On the cathode side, a reaction of producing two water molecules from four hydrogen ions, four electrons, and one oxygen molecule (the electrons produced in the anode in an adjacent one of MEAs move through the separator or the electrons produced in the anode of the cell at one end of the laminated-cell body reach the cathode of the cell at the other end of the laminated-cell body through an external circuit) occurs.

Anode Side: H₂→2H⁺+2e⁻

Cathode Side: 2H⁺+2e⁻+(½)O₂→H₂O

In order to cause the reactions mentioned above, fuel gas and oxidative gas are supplied to or discharged from the stack. For the movement of protons through the electrolytic membrane, it is required that the electrolytic membrane be wet. With a view to obtaining a suitably wet state of the electrolytic membrane, at least one of fuel gas and oxidative gas is humidified and supplied to the stack. However, if the stack is excessively humidified, flooding occurs in the downstream portion of an oxidative gas flow channel, which is especially likely to be humidified excessively due to the water produced. This causes a deterioration in the performance of the cell. For this reason, it is necessary to take a measure for drainage.

Japanese Patent Application Laid-Open No. 7-263003 discloses a fuel cell having a separator in which a plurality of S-shaped gas flow channels are formed in a separator face in parallel and independently of one another. Being curved into the shape of “S”, the flow channels are longer than straight gas flow channels. Thus, the flow rate of gas is increased and the penetration of gas into the diffusion layer is promoted. Also, gas stays in the gas flow channels for a long time. This is advantageous in humidifying the electrolytic membrane on the upstream side of the gas flow channels.

However, a fuel-cell separator having S-shaped gas flow channels has the following problems.

A. Because gas is consumed for reactions so as to generate power, the gas flow rate decreases as the distance from the downstream portions of the gas flow channels decreases. In the downstream portions of the S-shaped gas flow channel having a long length, therefore, a deterioration in the penetration of moisture into a diffusion layer, a deterioration in the drainage performance, and the occurrence of flooding emerge as problems, despite the advantage of this arrangement mentioned above.

B. A central portion of each of the S-shaped gas flow channels is adjacent to an inlet portion the flow channel. Therefore, a deterioration in the drainage performance in the downstream portions of the gas flow channels brings about a deterioration in the drainage performance of the entire separator region.

C. In the direction perpendicular to the gas flow channels, the upstream portion of a certain flow channel, the downstream portion thereof, the upstream portion of another flow channel, the downstream portion thereof, etc are located in this order. Thus, those regions with high gas concentrations and those regions with low gas concentrations are alternately arranged. This causes unevenness in the distribution of gas concentrations, and leads to a deterioration in the power generation performance.

### SUMMARY OF THE INVENTION

It is an object of the invention to provide a fuel-cell separator capable of improving the drainage performance of a downstream portion of a gas flow channel, improving the drainage performance of an entire separator region, and improving evenness in the distribution of gas concentrations. It is also an object of the invention to provide a fuel cell equipped with such a separator.

A first aspect of the invention relates to a fuel-cell separator. In this separator, a gas flow channel, in which an “inverse S”-shaped gas flow channel and an S-shaped gas flow channel are formed symmetrical to each other and converge at their downstream portions in such a manner as to have gas flow channel portions in common, is disposed in a separator face of the fuel-cell separator.

In the fuel-cell separator mentioned above, the “inverse S”-shaped gas flow channel and the S-shaped gas flow channel converge at their downstream portions in such a manner as to have the gas flow channel portions in common. Therefore the flow rate downstream of the confluent portion is increased in comparison with a case where the “inverse S”-shaped gas flow channel and the S-shaped gas flow channel do not converge.

As a result, the amount of moisture penetrating a diffusion layer is increased in the downstream portions. The effect of blowing moisture off is enhanced as well, and the drainage performance is improved. Owing to the improvement in the drainage performance, the occurrence of flooding is restrained.

It is to be noted herein that a fuel cell equipped with the separator of the first aspect of the invention is also within the scope of the invention.

### BRIEF DESCRIPTION OF THE DRAWINGS

The foregoing and further objects, features and advantages of the invention will become apparent from the following description of a preferred embodiment with reference to the accompanying drawings, wherein like numerals are used to represent like elements and wherein:

FIG. 1 is an exploded perspective view of a fuel cell stack into which a fuel-cell separator in accordance with the embodiment is incorporated;

FIG. 2A is a front view of a gas flow channel having a straight shape;

FIG. 2B is a front view of an S-shaped gas flow channel;

FIG. 2C is a front view of a gas flow channel of the fuel-cell separator in accordance with the embodiment;

FIG. 3A is a front view of the separator in the vicinity of inlet portions of gas flow channels;

FIG. 3D is a cross-sectional view taken along a line 3B-3B in FIG. 3A;

FIG. 4 is a cross-sectional view of gas flow channels on both sides of an MEA: and

FIG. 5 is a cross-sectional view in which one of the gas flow channels of the embodiment is compared with the gas flow channel shown in FIG. 2A.

### DETAILED DESCRIPTION OF PREFERRED EMBODIMENT

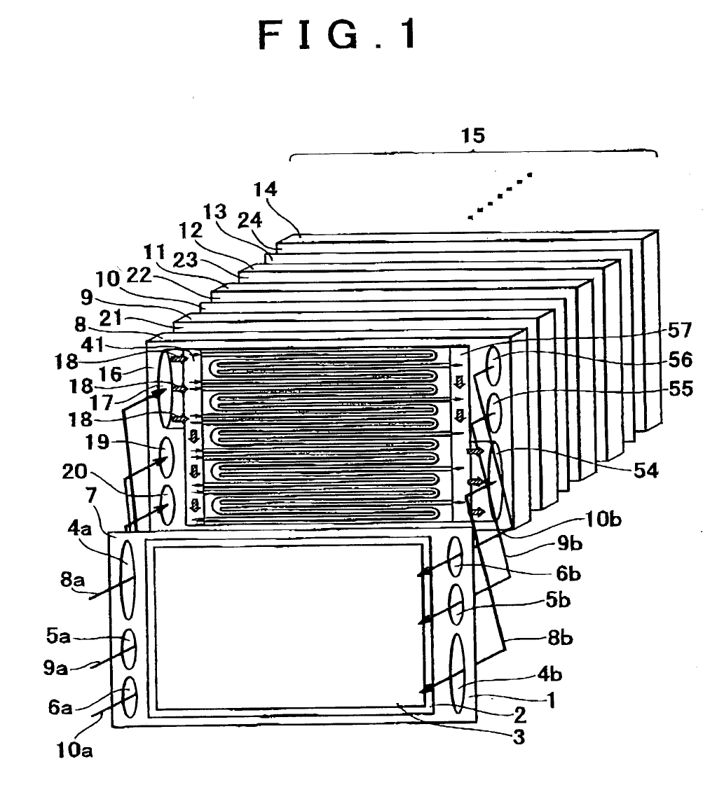

Hereinafter, the fuel-cell separator in accordance with the preferred embodiment of the invention will be described with reference to FIGS. 1 to 5.

A fuel cell to which the separator of this embodiment is applied is mounted in a fuel cell powered vehicle or the like. It is to be noted, however that the separator may be mounted in a non-vehicular object as well.

The fuel cell to which the separator of this embodiment is applied is a polymer electrolyte fuel cell. This fuel cell has a stack arrangement composed of laminated MEAs and separators. This stack arrangement coincides with the arrangement of the standard polymer electrolyte fuel cell described above as the related art, except for the arrangement of gas flow channels.

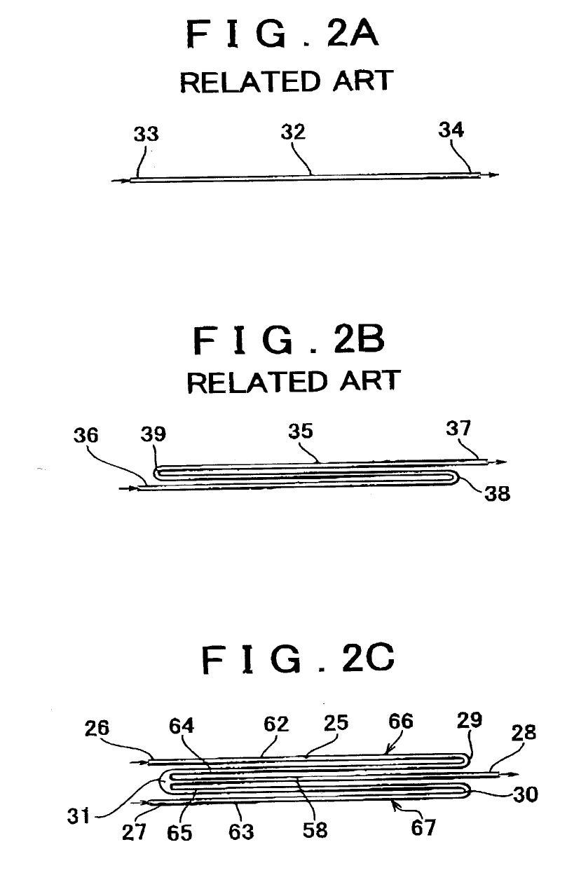

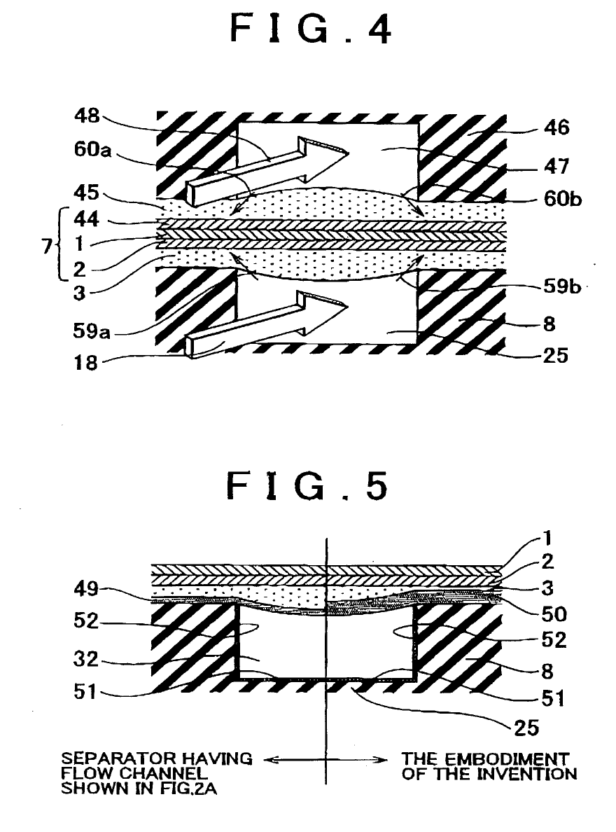

FIG. 1 shows part of a fuel cell stack into which the separator of the embodiment of the invention is incorporated. A gas flow channel of a separator 46 (FIG. 4) is on the front side. As is apparent from FIG. 1, a plurality of gas flow channels 25 shown in FIG. 2C are arranged in a separator face. Each of the gas flow channels 25 has inlet portions 26 and 27 and an outlet portion 28. The output portion 28 is smaller in cross-sectional area than the sum of cross-sectional areas of the inlet portions 26 and 27. It is also appropriate, however, that only one of the gas flow channels 25 be arranged in the separator face.

As shown in FIG. 2C, each of the gas flow channels 25 is composed of an “inverse S”-shaped gas flow channel 66 and an S-shaped gas flow channel 67 The gas flow channels 66 and 67 are formed symmetrical to each other and converge at their downstream portions into a common gas flow channel portion. As shown in FIG. 1, the flow channel 25 is arranged in the separator face.

As shown in FIG. 2c, the “inverse S”-shaped gas flow channel 66 and the S-shaped gas flow channel 67 have inlet portions 26 and 27, first linear portions 62 and 63, first curved portions (also referred to as a first turn portions) 29 and 30, second linear portions 64 and 65, a second curved portion (also referred to as a second turn portion or a confluent portion) 31, a third linear portion (also referred to as a confluent flow channel) 58, and an outlet portion 28, respectively. The inlet portions 26 and 27, the first linear portions 62, 63, the first curved portions 29 and 30, the second linear portions 64 and 65, the second curved portion 31, the third linear portion 58, and the outlet portion 28 are arranged in this order in a direction from the upstream side to the downstream side. The second linear portions 64 and 65 converge at the second curved portion (the second turn portion) 31. The third linear portion 58 and the outlet portion 28 constitute the common gas flow channel portions that belong to both the “inverse S”-shaped gas flow channel 66 and the S-shaped gas flow channel 67.

The common gas flow channel portions 31, 58, and 28 of each of the gas flow channels 25, into which the “inverse S”-shaped gas flow channel 66 and the S-shaped gas flow channel 67 are combined, are located between the second linear portion 64 of the “inverse S”-shaped gas flow channel 66 and the second linear portion 65 of the S-shaped gas flow channel 67.

The cross-sectional area of the common gas flow channel portions 31, 58 and 28 is smaller than the sum of cross-sectional areas of non-common gas flow channel portions 62 and 63 or the sum of cross-sectional areas of non-common gas flow channel portions 29 and 30 or the sum of cross-sectional areas of non-common gas flow channel portions 64 and 65 that are located upstream of the confluent portion 31.

In the example shown in FIG. 1, the gas flow channels 25, into each of which the “inverse S”-shaped gas flow channel 66 and the S-shaped gas flow channel 67 are combined, are formed in the single separator face.

FIG. 1 also shows an MEA 7 laminated on the separator 46 via a diffusion layer 45. As shown in FIG. 4, the MEA 7 is composed of an electrolytic membrane 1 and electrodes 2 and 44. The electrolytic membrane 1 is pervious to hydrogen ions. Each of the electrodes 2 and 44 is formed on a corresponding one of faces of the electrolytic membrane 1 While the electrode formed on one face of the electrolytic membrane 1 is an anode, the electrode formed on the other face of the electrolytic membrane 1 is a cathode. The electrodes 2 and 44 are mainly made from carbon, into which platinum as a substance serving as a catalyst is mixed. On each side of the MEA 7, a corresponding one of diffusion layers 3 and 45 is disposed between the MEA 7 and the separator. For the purpose of utilizing gas efficiently, each of the diffusion layers 3 and 45 is adapted to allow gas to spread as widely as possible over the entire face of a corresponding one of the electrodes. As shown in FIG. 1, holes 4a, 5a and 6a are opened in the MEA 7. Oxidative gas 8a, fuel gas 9a, and coolant 10a flow through the holes 4a, 5a and 6a respectively. In this embodiment, air is used as the oxidative gas 8a and hydrogen is used as the fuel gas 9a.

The oxidative gas 8a that has flown through the hole 4a of the MEA 7 flows into a feed manifold 17 of an air separator 8 for a cathode. The air separator 8 is laminated on the MEA 7 and formed such that an air flow channel 25 is in contact with the MEA 7. The feed manifold 17 opened in the air separator a in the same manner as in the MEA 7. In cooperation with the hole 4a of the MEA 7, the feed manifold 17 allows the oxidative gas 8a to be supplied to the air flow channel 25 of the air separator 8. The fuel gas 9a is introduced into its flow channel through a hydrogen-feed manifold 19 having a similar construction, and the coolant 10a is introduced into its flow channel through a coolant-feed manifold 20 having a similar construction.

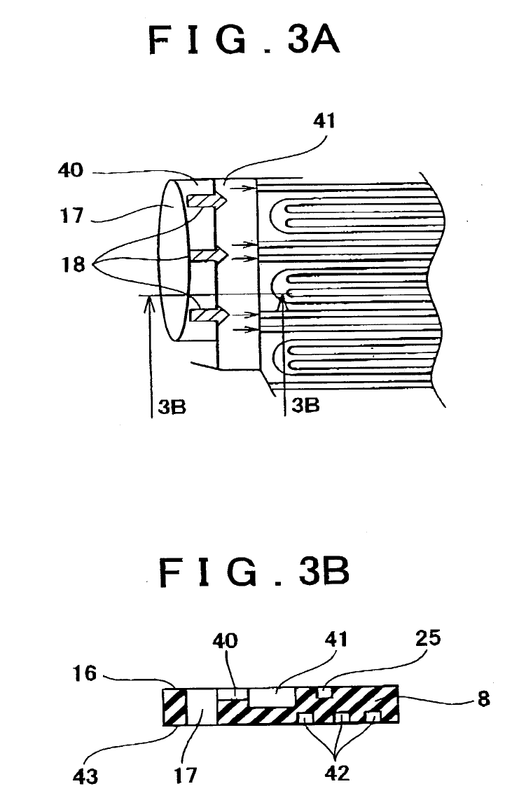

As shown in FIG. 3, coolant flow channels 42 are formed in a back face 43 that forms the air flow channel 25 of the air separator 8. By being integrated with a coolant flow channel (not shown), the coolant flow channels 42 constitute a flow channel for the coolant 10a. The coolant flow channel is formed in a coolant flow channel face 21 of a hydrogen separator 9 for an anode, which is to be laminated subsequently. A hydrogen flow channel (not shown) through which the fuel gas 9a flows is formed in a back face (not shown) of the coolant flow channel face 21 of the hydrogen separator 9. The back face of the coolant flow channel face 21 is in contact with an MEA 10, which is to be newly laminated. In the sequence described hereinbefore, the separators 8 and 9, separators 11, 12 and 14, the MEAs 7 and 10, and an MEA 13 are laminated. In combination with additional separators and MEAs, the separators 8, 9, 11, 12 and 14 and the MEAS 7, 10 and 13 constitute a fuel cell stack 15.

The fuel cell stack 15 has manifolds and holes. Each of these manifolds and each of these holes form a pair with a corresponding one of the feed manifolds 17, 19 and 20. Each of the oxidative gas 8a, the fuel gas 9a, and the coolant 10a flows through a flow channel formed in a corresponding one of the separators. Each of these fluids turns into a corresponding one of oxidative gas 8b, fuel gas 9b, and coolant 10b. The oxidative gas 8b, the fuel gas 9b, and the coolant 10b are discharged from the fuel cell stack 15 through exhaust manifolds 54, 55 and 56 respectively

It will now be described how the oxidative gas 8a flows through the air separator 8, with reference to FIGS. 1, 2C, 3A and 3B.

Humidified air 18 that has been supplied from the air-feed manifold 17 and that is to be introduced into the air separator 8 is introduced into an introduction channel 40. An air flow channel face 16 of the air separator 8 is provided with the introduction channel 40. The introduction channel 40 is manufactured so as to be lower than the air flow channel face 16, and forms a passage for introducing the humidified air 18. The introduction channel 40 connects the air-feed manifold 17 to an inlet distribution portion 41, which will be described later. The introduction channel 40 introduces a predetermined amount of the humidified air 18 into an air flow channel 25. The air flow channel 25 is also formed in the air flow channel face 16 and extends from the inlet distribution portion 41. In FIG. 3, the inlet distribution portion 41 has a sufficiently large volume for the sum of cross-sectional areas of the flow channels 26, 27 (FIG. 2C) and other flow channel inlets, so that the humidified air 18 introduced from the introduction channel 40 can be substantially evenly distributed. The inlet distribution portion 41 leads to each of the flow channel inlets.

Referring to FIG. 4, the MEA 7 and the diffusion layers 3, 45 are sandwiched between two separators, namely, the air separator 8 and the hydrogen separator 46, such that the diffusion layer 3 is pressed against the face of the MEA 7 on the side of the air flow channel 25 and that the diffusion layer 45 is pressed against the face of the MEA 7 on the side of a hydrogen flow channel 47. Accordingly, each of the flow channels 25 and 47 has a generally rectangular cross-sectional shape, with three sides being defined by a corresponding one of the separators 8 and 46 and with the other side being defined by a corresponding one of the diffusion layers 3 and 45. The air 18 and hydrogen 48 mostly flow through the flow channels 25 and 47 but partially penetrate the diffusion layers 3 and 45 as well. Causing a large of amount of air 59a and 59b and hydrogen 60a and 60b to penetrate the diffusion layers 3 and 45 respectively is an effective method for making gas reactions possible on a larger plane. The sequence in which the air separator 8 constituting the air flow channel 25, the hydrogen separator 46 constituting the hydrogen flow channel 47 and the coolant flow channel (not shown), and the MEA 7 are laminated is not limited. These components may be laminated in any sequence as long as the function of a fuel cell is theoretically guaranteed.

Next, it will be described with reference to FIG. 5 how moisture penetrates the diffusion layer in the case where the flow channel is formed in the separator as shown in FIG. 2C (the embodiment) and in the case where the flow channel is formed in the separator as shown in FIG. 2A.

In the case of the flow channel 32 shown in FIG. 2A, the humidified air 18 flows toward the outlet 34 through the inlet 33 At this moment, moisture contained in the humidified air 18 moistens the entire flow channel 32 and promotes gas reactions. However, the diffusion layer 3 is intended merely for the penetration of gas. In general, therefore, the diffusion layer 3 has water repellency and is inferior in the function of retaining moisture. In the case of the flow channel 32 shown in FIG. 2A, therefore, a small amount of moisture (moisture 49) contained in the humidified air 18 penetrates the diffusion layer 3 together with the humidified air 18, and a small amount of moisture (moisture 51 and moisture 52) adheres to the flow channel 32, as is apparent from the left half of FIG. 5. However together with the humidified air 18, most of the moisture flows through the flow channel 32 that is low in pressure loss. For this reason, a sufficient amount of moisture required for power generation cannot be retained in the diffusion layer 3. As a result, the power generation performance cannot be improved in low humidity. In the case where the separator of the embodiment of the invention is used, however, a larger amount of moisture 50 penetrates the diffusion layer 3 in comparison with a case where a separator having flow channels as shown in FIG. 2A is used, as is apparent from the right half of FIG. 5.

In the embodiment of the invention, for each one of the flow channels, there is one outlet, namely, the outlet 28 leading to the outlet distribution portion 57 from the flow channel 25. However, the outlet 28 is connected via the first linear portions 62 and 63, first curved portions 29 and 30, second linear portions 64 and 65, a second curved portion 31, and a third linear portion 58 to the two inlets 26 and 27. That is, the humidified air 18 that has flown into the flow channel 25 through the inlets 26 and 27 from the inlet distribution portion 41 flows into the second turn portion 31 through the first turn portions 29 and 30, respectively In the second turn portion 31, the humidified air 18 converges into and mixes with the humidified air 18 flowing from the first turn portions 29 and 30, and flows toward the outlet 28 through the single flow channel 58.

As for the flow channels of the separator, each one of the flow channels 32 generally has the single inlet 33 and the single outlet 34, as is apparent from FIG. 2A. The flow channel shown in FIG. 2B with further improved performance has a curved flow channel 35 that is composed of an inlet 36, an outlet 37, a first turn portion 38, and a second turn portion 39. The humidified air 18 that has flown inside through the inlet 36 flows through the first turn portion 38, changes its direction in the second turn portion 39, and then flows toward the outlet 37.

In the embodiment of the invention, for each one of the flow channels, the humidified air 18 that has flown inside through the two inlets 26 and 27 is discharged from the single outlet 28. At this moment, the pressure applied to the entire flow channel 25 is higher than the pressure applied to the flow channel 32 shown in FIG. 2A or the pressure applied to the flow channel 35 shown in FIG. 2B. Therefore, the humidified air 18 flowing through the embodiment of the invention more deeply penetrates the diffusion layer 3 defining one face of the flow channel 25 than the diffusion layer defining one face of the flow channel 32 shown in FIG. 2A or the flow channel 35 shown in FIG. 2B (FIG. 5). The amount of humidified air 18 condensed and retained in the diffusion layer 3 as moisture is increased by raising saturation vapor pressure for an increase in pressure as well. This moisture is not easily carried away by the humidified air 18 flowing through the flow channel 25. Due to an increase in the pressure applied to the flow channel, the operation of deep penetration of the humidified air 18 into the diffusion layer 3 occurs on all the faces of the air flow channel 25. As a result, moisture 50 deeply and widely penetrates the entire diffusion layer 3 and is retained.

As described above, the two inlets 26 and 27 have the single outlet 28 in common. This creates the operation and effect of reducing flow channel area. As a result, the pressure applied to the entire flow channel 25 is increased, and the moisture that has been introduced into the flow channel 25 by the humidified air 18 stays in the diffusion layer 3. The amount of this moisture is sufficient for the amount of moisture required for gas reactions. Thus, low-humidity operation of the fuel cell is made possible.

Because the humidified air 18 that has flown inside from the two inlets 26 and 27 flows out through the single outlet, an flow rate in the central confluent flow channel 58 is increased. Therefore, the discharge of the moisture is promoted in comparison with a case where a separator having flow channels as shown in FIG. 2B is used and thus can prevent a deterioration in the performance resulting from the stagnation of moisture in high humidity.

The aforementioned arrangement has been described according to the example of the air flow channel 25. However, even if the aforementioned arrangement is applied to a hydrogen flow channel, the operation and effect similar to those of the embodiment of the invention can be expected. As a matter of course, even if the aforementioned arrangement is applied to both an air flow channel and a hydrogen flow channel, the operation and effect similar to those of the embodiment of the invention can be expected.

According to the fuel-cell separator mentioned above, the “inverse S”-shaped gas flow channel and the S-shaped gas flow channel converge at their downstream portions into the common gas flow channel portion Therefore, the flow rate downstream of the confluent portion is increased in comparison with a case where the “inverse S”-shaped gas flow channel and the S-shaped gas flow channel do not converge into the common gas flow channel portion.

As a result, the amount of moisture penetrating the diffusion layer in the downstream portion is increased. The effect of blowing moisture off is also enhanced, and the drainage performance is improved. Due to an improvement in the drainage performance, the occurrence of flooding is restrained.

According to the fuel-cell separator mentioned above, each of the “inverse S”-shaped gas flow channel and the S-shaped gas flow channel has the inlet portion, the first linear portion, the first curved portion, the second linear portion, the second curved portion, the third linear portion, and the outlet portion, which are arranged in this order in the direction from the upstream side to the downstream side. The “inverse S”-shaped gas flow channel and the S-shaped gas flow channel converge at the second curved portion. The third linear portion and the outlet portion constitute the common gas flow channel portion. Therefore, the confluent portion is adjacent to the inlet portion leading to the flow channel. Even if the region in the vicinity of the inlet portion becomes excessively humid, the drainage of moisture contained in the excessively humid region is promoted by the confluent gas flow channel with an increased flow rate. It is thus possible to prevent the entire separator region from deteriorating in the drainage performance.

In addition, according to the fuel-cell separator mentioned above, the common gas flow channel portion into which the “inverse S”-shaped gas flow channel and the S-shaped gas flow channel converge is located between the second linear portion of the “inverse S”-shaped gas flow channel and the second linear portion of the S-shaped gas flow channel. In the direction perpendicular to the gas flow channel, therefore, the upstream portion, the confluent downstream portion, and the upstream portion are arranged in this order. The gas concentration in the confluent downstream portion is increased in comparison with a case where the “inverse S”-shaped gas flow channel and the S-shaped gas flow channel do not converge. Therefore, the gas concentration in the direction perpendicular to the gas flow channel is homogenized, and the power generation performance is improved.

According to the fuel-cell separator mentioned above, the gas flow channel in which the “inverse S”-shaped gas flow channel and the S-shaped gas flow channel converge is formed in the separator face. Therefore, the distribution of gas concentrations in the entire separator face can be homogenized, and the power generation performance is improved.

According to the fuel-cell separator mentioned above, the cross-sectional area of the common gas flow channel portion is smaller than the sum of cross-sectional areas of the non-common gas flow channel portions Therefore, the gas flow rate in the confluent portion and the region downstream thereof can be increased, and the effect of blowing moisture off can be reliably achieved.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

What is claimed is:

1. A fuel-cell separator comprising:
a gas flow channel, in which an “inverse S”-shaped gas flow channel and an S-shaped gas flow channel are formed symmetrical to each other and converge at their downstream portions in such a manner as to have gas flow channel portions in common, that is disposed in a separator face of the fuel-cell separator.

2. The fuel-cell separator according to claim 1, wherein
the “inverse S”-shaped gas flow channel and the S-shaped gas flow channel have inlet portions, first linear portions, first curved portions, second linear portions, a second curved portion, a third linear portion, and an outlet portion, which are arranged in this order in a direction from the upstream side to the downstream side,
the “inverse S”-shaped gas flow channel and the S-shaped gas flow channel converge at the second curved portion, and
the third linear portion and the outlet portion constitute the common gas flow channel portion.

3. The fuel-cell separator according to claim 2, wherein
the common gas flow channel portion of the gas flow channel, into which the “inverse S”-shaped gas flow channel and the S-shaped gas flow channel converge, is located between the second linear portion of the “inverse S”-shaped gas flow channel and the second linear portion of the S-shaped gas flow channel.

4. The fuel-cell separator according to claim 2, wherein
the cross-sectional areas of the third linear portion and the outlet portion are smaller than at least one of sum of cross-sectional areas of inlet portions of the “inverse S”-shaped gas flow channel and the S-shaped gas flow channel, and sum of cross-sectional areas of first linear portions of the “inverse S”-shaped gas flow channel and the S-shaped gas flow channel, and sum of cross-sectional areas of first curved portions of the “inverse S”-shaped gas flow channel and the S-shaped gas flow channel, and sum of cross-sectional areas of second linear portions of the “inverse S”-shaped gas flow channel and the S-shaped gas flow channel.

5. The fuel-cell separator according to claim 4, wherein
the cross-sectional areas of the third linear portion and the outlet portion, the inlet portions, the first linear portions, the first curved portions and the second linear portions are perpendicular to gas flow direction in the respective portions.

6. The fuel-cell separator according to claim 1, wherein
the gas flow channel in which the “inverse S”-shaped gas flow channel and the S-shaped gas flow channel converge is formed in the separator face.

7. The fuel-cell separator according to claim 1, wherein
a plurality of gas flow channels in which the “inverse S”-shaped gas flow channel and the S-shaped gas flow channel converge are formed in the separator face.

8. The fuel-cell separator according to claim 1, wherein
the gas flow channel is an oxidative gas flow channel.

9. The fuel-cell separator according to claim 1, wherein
the gas flow channel is a fuel gas flow channel.

10. The fuel-cell separator according to claim 1, wherein
the gas flow channels are an oxidative gas flow channel and a fuel gas flow channel respectively.

11. The fuel-cell separator according to claims 10, wherein
the oxidative gas flow channel is disposed on a cathode of a cell of a fell cell; and
the fuel gas flow channel is disposed on an anode of the cell of the fell cell.

12. The fuel-cell separator according to claim 1, wherein
the cross-sectional area of the common gas flow channel portions is smaller than the sum of cross-sectional areas of non-common gas flow channel portions that are located upstream of a confluent portion.

13. The fuel-cell separator according to claim 12, wherein
the cross-sectional areas of the common gas flow channel portions and the non-common gas flow channel portions are perpendicular to gas flow direction in the respective portions.

14. A fuel cell by comprising:
the separator according to claim 1.

15. The fuel cell according to claim 14, wherein
the fuel cell is a polymer electrolyte fuel cell.
